(19) United States
(12) Patent Application Publication
(10) Pub. No.: US 2020/0310222 A1
(43) Pub. Date: Oct. 1, 2020

(54) FULLY CUSTOMIZED INTEGRATED ON-BOARD INTERNET CAMERA MASKING MECHANISM

(71) Applicants: Kurt Bulawa, Lakewood, CO (US); Trang Tran, Lakewood, CO (US)

(72) Inventors: Kurt Bulawa, Lakewood, CO (US); Trang Tran, Lakewood, CO (US)

(21) Appl. No.: 16/368,869

(22) Filed: Mar. 29, 2019

(51) Int. Cl. G03B 11/04; G06F 1/16; H04N 5/225

(52) U.S. Cl. CPC G03B 11/041; H04N 5/2257; G06F 1/1656

(57) ABSTRACT

Various methods, systems, and devices are described for iteratively masking and exposing integrated onboard cameras on electronic devices including laptops, tablets, and mobile phones. A User, such as an employee, an affiliated member of an organization, or independent consumer may leverage this integrated onboard camera masking solution to create privacy and/or exposure for the intended use of the camera at their direct specification. The User can change the configuration using their fingertip numerous times. The User can display this camera masking solution proudly with an identifiable message or graphic symbol that they feel represents them—thus giving the User the ability to express themselves openly to other individuals. The camera masking solution also enables worry-free usage as it will not detach, break apart, or change configurations spontaneously based on basic User movements with the device. The solution will also not hinder the use of or damage the electronic device during its normal usage because it has a small footprint and it near paper thin in its construction.

### TECHNICAL FIELD

The present exemplary system and method relate to surveillance, monitoring, and security devices. More particularly, the present exemplary system and method relate to masked cameras and have that solution be a thin as a piece of paper on your device so it doesn't risk damaging it or being damaged during use.

### BACKGROUND OF THE INVENTION

Recently, webcams have become nearly standard equipment on notebook computers, as well as tablets and smart phones. Most webcams on notebook computers, tablets, and smart phones do not include a privacy shield. This may be due to market demands for thin form factors or other reasons. Internet cameras as standard equipment on all mobile electronic devices including cell phones, tablets, and laptops.

The threat of being hacked is equally prevalent and certainly much easier to do at the individual level than what we've seen in the news with target, yahoo, and LinkedIn just to name a few. Cameras embedded within these devices are just as vulnerable to being hacked and many times more revealing because it provides video capability into your personal living space.

If no privacy shield is included, malware may be able to hijack the webcam without the user's permission or knowledge, which may allow the malware to spy on the user, invading their privacy. Still and/or video images acquired by the malware may be embarrassing, or even dangerous, to the user. In some cases, images from the malware have been posted to social media sites, embarrassing the subject of the images and leading to potential damage to the subject's social and business relationships. Criminals may even attempt to use such images to blackmail the subject. Users of traditional webcams can avert hijacking of the webcam by simply unplugging the webcam, but if the webcam is built into the device, and the device needs to be left on for some reason, this is not possible. This leaves people that may engage in activities that they wish to keep private vulnerable to malware which may hijack the webcam of a nearby device.

There are solutions on the market to cover the camera of varying capabilities from simple tape to a device equipped with a moveable window to block and unblock the camera for use. However, there is no solution on the market today that allows the user to securely block and unblock the camera with a reliable mechanism, provides the ability to custom-brand the entire solution, and have that solution be a thin as a piece of paper on your device so it doesn't risk damaging it or being damaged during use.

### A BRIEF SUMMARY OF THE INVENTION

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The Blindside™ is a near paper-thin solution that leverages adhesive to stick to the electronic device and either low-tack adhesive or magnetic substrate to enable a retractable door to be opened and closed on-demand that exposes the onboard camera for consensual use. The top face of the solution enables a substrate to be fully custom-branded in 4-colour printing. the design can be of anything from a company/custom graphics logo, state/country flags, college/university brands, foreign language [i.e. chinese character symbols], professional sports team brands, basic colors, recognized global symbols [i.e. yin/yang, political, religious], sports symbols, cpg logos [i.e. coke/mountain dew], cartoon faces [i.e. mickey mouse], pictures of personal friends/family members, or anything that can be graphically designed. there are two basic embodiments of this solution: one with a retractable detached door that slides and stays adhered to the base via magnetism; and two with a retractable attached door that is peeled away when the camera needs to be exposed for use and pressed in place with adherence from a low-tack substrate while the door is attached via a thin hinge on the side.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description, figures, and claims.

### BRIEF DESCRIPTION OF THE DRAWINGS

The accompanying drawings, which are incorporated in and constitute part of the specification, illustrate various embodiments. Together with the general description, the drawings serve to explain the principles of the invention. They should not, however, be taken to limit the invention to the specific embodiment(s) described, but are for explanation and understanding only. In the drawings:

FIG. 1 illustrates a simulated open laptop lid that identifies where the camera would be positioned in addition to the camera indicator light. Depending on the device, the onboard camera can be positioned in nearly any spot of the screen footprint. Tablets, phones, and laptops all have cameras that can and should be masked when not in use.

FIG. 2 illustrates a simulated open laptop lid where the detached, magnetic embodiment masking device solution is placed over the onboard camera with the retractable door slid to the left to mask the camera from any ability to be used which can be leveraged for all devices that have integrated cameras: tablets, phones, and laptops. note that the camera masking solution has the ability to be custom branded so that it's not as intrusive looking like a piece of ripped post-it note or miscellaneous piece of tape which are commonly used to mask onboard cameras.

FIG. 3 illustrates a simulated open laptop lid where the detached, magnetic embodiment masking device solution is placed over the onboard camera with the retractable door slid to the right to expose the camera for use. This solution allows the masking and exposure of onboard cameras for all devices that have integrated cameras: tablets, phones, and laptops.

FIG. 4 illustrates a simulated open laptop lid similar to FIG. 3 with the retractable door slid to the left to mask the camera from any ability to be used. This embodiment illustrates further the ability to custom design the size of the base portion of the masking device to contain additional designs/messaging being prescribed by the client. This would be the case for companies that provide this device to employees and want to promote other messages, numbers, etc. along with providing the security of the masking device. Any size and shape can be accommodated with this masking device per the client's specifications.

FIG. 5 illustrates a magnified view of the camera masking solution. the base unit on the left will have high-tack adhesive on the reverse side to adhere to the device that houses the integrated camera device and a metallic or magnetic property on the top side. the retractable door on the right side will have magnetic properties on the reverse side such that it will adhere to anything metallic or counter magnetic. The topside of the retractable door can be custom branded to the specifications of the client and the topside of the base portion can also be custom branded however the red ring about the camera exposure window will stay to alert the user that their privacy from the camera is not guaranteed. There will also be the standard language for “privacy” and “no privacy” messaging along with product branding text on the base.

FIG. 6 illustrates a magnified view of the camera masking solution as it is to be used to mask and expose the integrated onboard camera on the device. the magnetic embodiment version of the solution illustrates how the detached magnetically adhered retractable door can slide from right to left to mask the integrated onboard camera and left to right to expose the camera by using a finger.

FIG. 7 illustrates a magnified view of the magnetic, detached door embodiment camera masking solution for the purposes of production. The top portion of the figure illustrates the overhead topside view descriptions of the camera masking solution—for the base and detached door. The lower portion of the figure describes the underside view of the camera masking solution—for the base and detached door. The topside of the base describes that it shall have magnetic or metallic properties such that the magnetized detached door would be attracted to it when positioned on it. The underside of the base shows that it shall have high-tack adhesive such that it can adhere to the device containing an integrated onboard camera. The topside of the magnetic detached door shall have the ability to be custom branded with 4-colour printing. The underside of the magnetic detached door shall have magnetic properties such that is has the natural attraction to the base when positioned over it.

FIG. 8 illustrates a magnified view of the camera masking solution with specified dimensions of the standard footprint and thus the smallest footprint prescribed by the manufacturer of both the base portion of the solution and the detached retractable door. the views displayed are overhead views and the side view to illustrate the near paper-thin construction.

FIG. 9 illustrates a magnified view of the camera masking solution with specified dimensions of the standard footprint and thus the smallest footprint prescribed by the manufacturer in this embodiment of both the base portion of the solution and the attached retractable door. The view displayed is the side view to illustrate the near paper-thin construction. Also illustrated is a magnified view of the low-tack attached door embodiment camera masking solution for the purposes of production. The top portion of the figure illustrates the overhead topside view descriptions of the camera masking solution—for the base and detached door. The lower portion of the figure describes the underside view of the camera masking solution—for the base and detached door. The topside of the base describes that it shall have glossy properties such that the low-tack attached door would adhere to it when positioned on it. The underside of the base shows that it shall have high-tack adhesive such that it can adhere to the device containing an integrated onboard camera. The topside of the low-tack attached door shall have the ability to be custom branded with 4-colour printing. The underside of the low-tack attached door shall have marginal adhesive properties such that have the natural ability to adhere to the base when positioned over it.

FIG. 10 illustrates a magnified view of the camera masking solution with specified dimensions of the standard footprint and thus the smallest footprint prescribed by the manufacturer in this embodiment of the base portion of the solution only with the attached retractable door to the right but terminated for illustration purposes. The view displayed is the overhead view to illustrate the dimensions of the footprint and the window for the integrated onboard camera.

FIG. 11 illustrates a magnified view of the camera masking solution with specified dimensions of the standard footprint and thus the smallest footprint prescribed by the manufacturer in this embodiment of the retractable door portion of the solution only. the view displayed is the overhead view to illustrate the dimensions and features of the footprint and that the retractable, attached door can be custom branded to the specification of the client.

FIG. 12 &13 illustrate an alternative embodiment of the magnetic detached slide design where the base of the solution includes a circumference lip around 3 of the four sides of the base to protect the top slide piece from being inadvertently knocked off by the user. The base of the solution would be either conductive, pressed sheet metal with narrowly raised circumference lip to protect the top piece slide from falling off. The base could also be another material (i.e. plastic, rubber, silicone, etc.) and have a magnetic substrate embedded that would also include the circumference lip. The top side slide would be a magnetic substrate that would be attracted to the base and customer design printed and dies cut to the specifications of the customer.

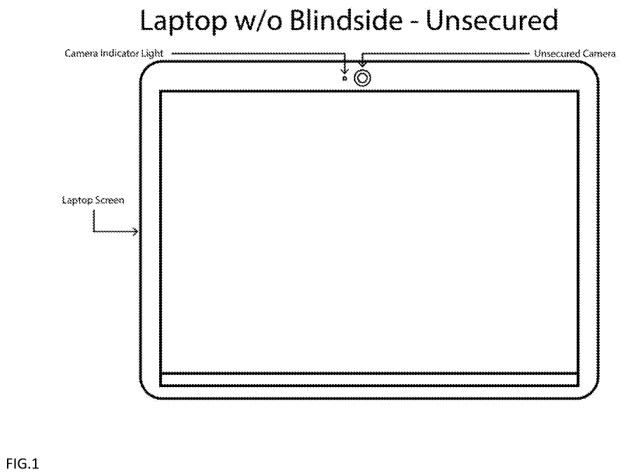

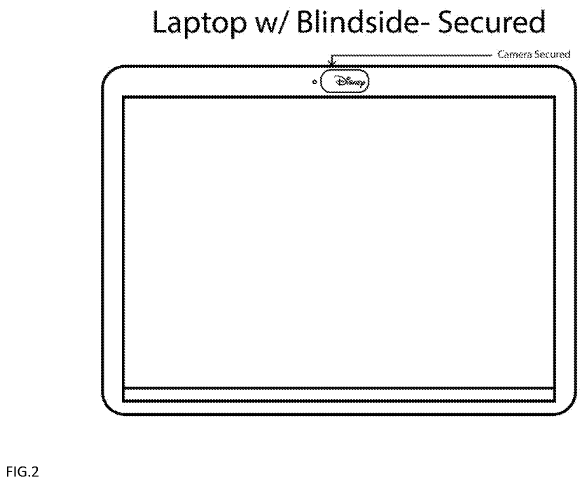

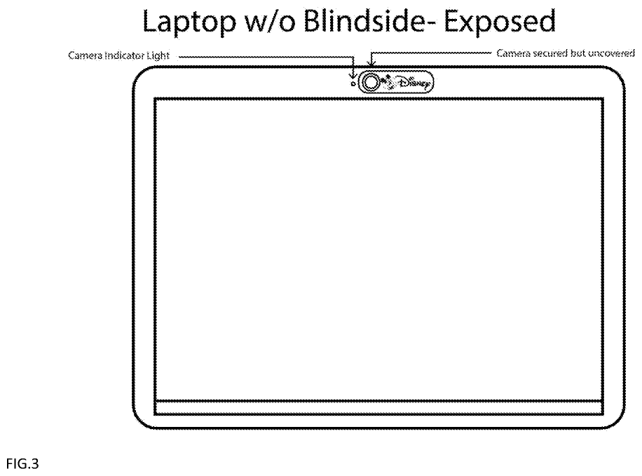

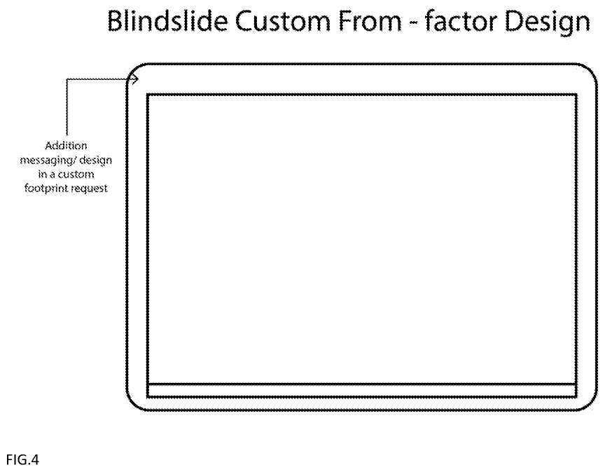

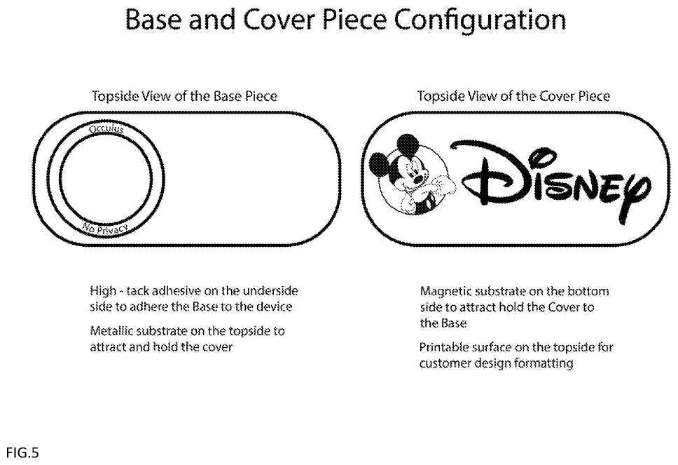

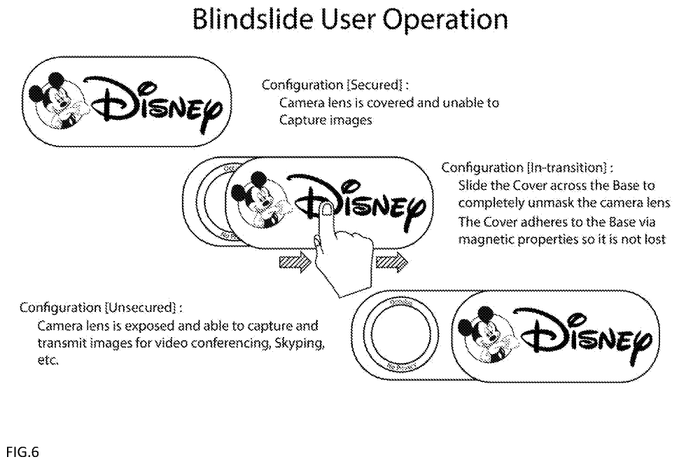

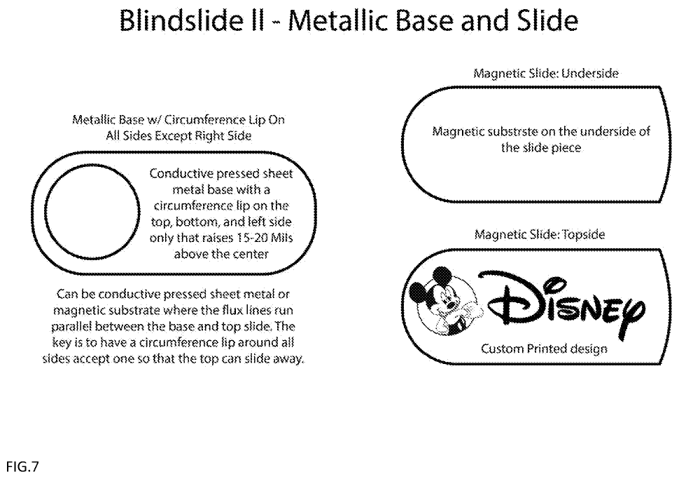

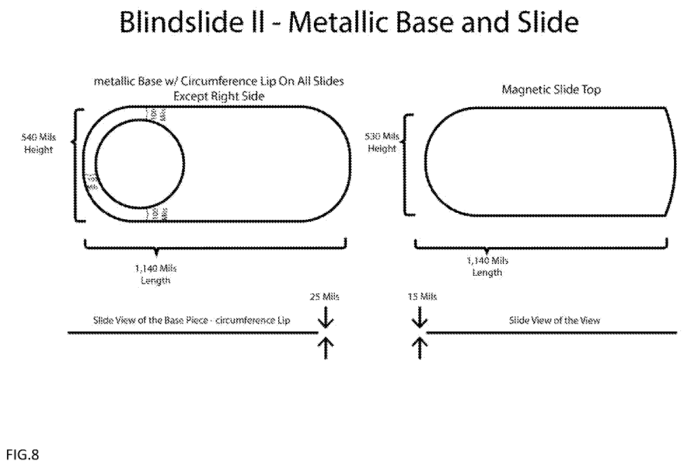

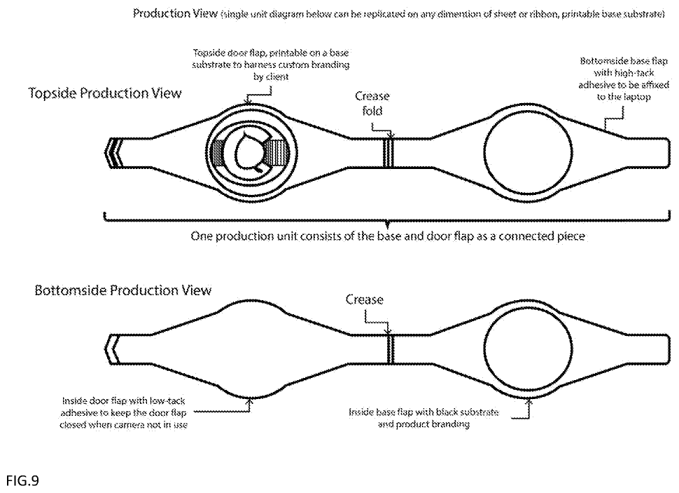

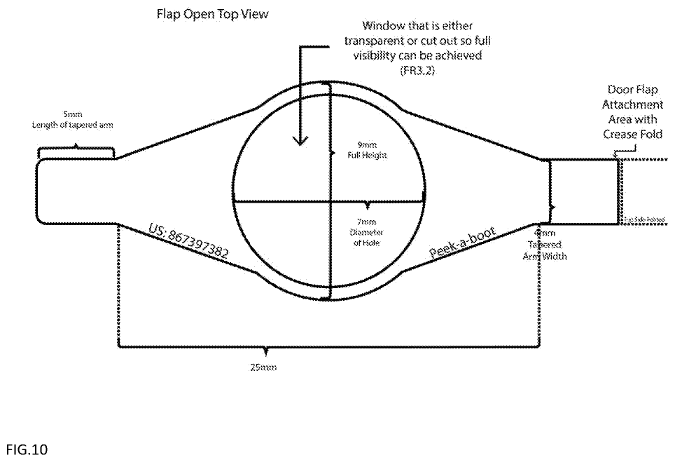

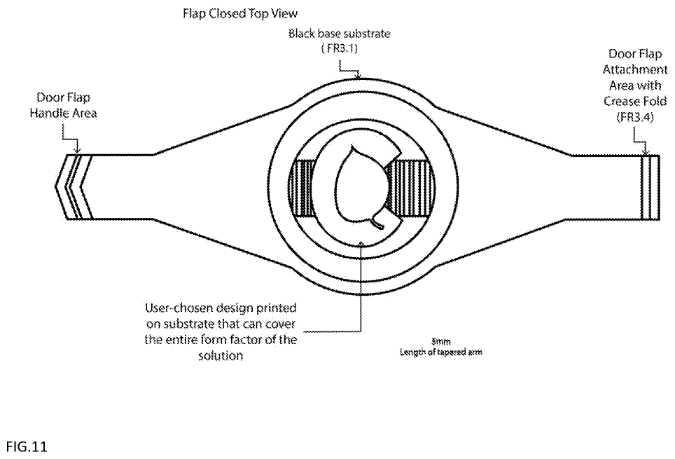

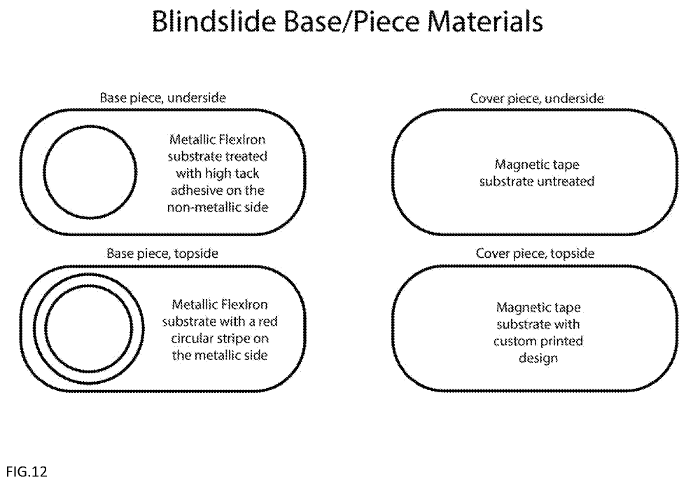

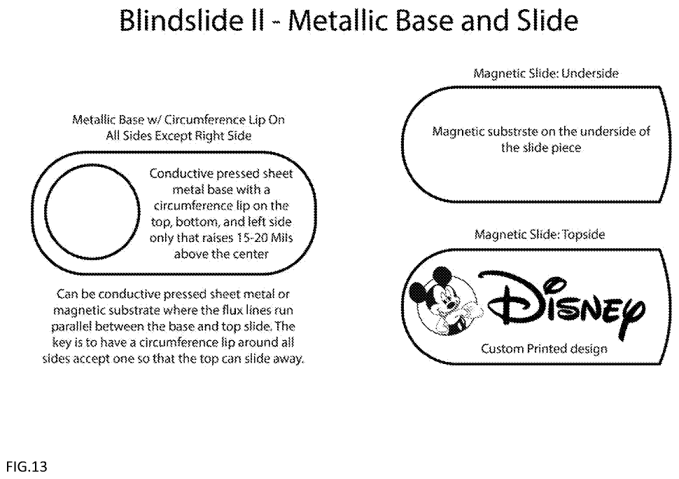

### A DETAILED DESCRIPTION OF THE INVENTION

in the following detailed description, numerous specific details are set forth by way of examples in order to provide a thorough understanding of the relevant teachings. However, it should be apparent to those skilled in the art that the present teachings may be practiced without such details. In other instances, well known methods, procedures and components have been described at a relatively high-level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification. Some descriptive terms and phrases are presented in the following paragraphs for clarity.

This product contains two basic embodiment versions—each containing similar features of value for the market. The first embodiment configuration is of a camera masking solution that has a retractable, attached door that affixes to the base via low-tack adhesive when closed and can peel open to expose the camera for use. The second embodiment configuration is of a camera masking solution that has a retractable, detached door that affixes to the base via magnetic properties and is slid left or right to expose the camera for use or mask it from being used. Both embodiments have the same unique features illustrated in this section.

The first major feature is the custom brandability. This integrated onboard camera masking solution is constructed on the top-side with a substrate such that it can be printed upon with a full 4-colour design chosen or provided by the client. the entire footprint of the base and the door of the solution will have the ability to be custom branded per the client's specification such that it can deliver a message from the user to everyone of something they identify with (e.g. a company/custom graphics logo, state/country flags, college/university brands, foreign language [i.e. Chinese character symbols], professional sports team brands, basic colors, recognized global symbols [i.e. yin/yang, political, religious], sports symbols, cpg logos [i.e. coke/mountain dew], cartoon faces [i.e. mickey mouse], pictures of personal friends/family members, or anything that can be graphically designed)

The second major feature is the form factor footprint. this integrated onboard camera masking solution has a flexible form-factor footprint that is designed with material to be near paper-thin which assures that your electronic device won't be adversely affected by using this solution (i.e. cracked screen, bending the laptop plastic due to bulkiness, inadvertent mouse button compression when the lid is closed, etc.) nor will it interfere with the electronic device while in use (i.e. won't feel different, force habits to change on how to hold or grip the device, etc.). There are no separate or distinct mechanical parts to break or become dislodge. In addition to being paper-thin, the solution can be as small in form-factor as a dime or as large as the customer would like to equip it with supplementary messaging for the user (i.e. a corporate message to employees, a commercial message for customers, etc.).

The third major feature is the seamless convertibility. depending on the embodiment type of the integrated onboard camera solution, it has either a tethered, retractable door that stays open or closed via the assistance of low-tack adhesive ad a small crimped hinge on the side of the door adheres to the base via magnetic properties where the user can slide the door left/right to create privacy/exposure without the door mechanism every leaving the surface of the base. The base layer of the solution will have a circular cutout or translucent window in which the integrated onboard camera would be allowed to capture video as designed. The door mechanism will be reliably retractable and stable enough to remain the desired position until deliberately moved by the user—unlike other mechanical devices that move based on gravity or electronic device movements.

As used in this specification and the appended claims, the singular forms “a”, “an”, and “the” include plural referents unless the content clearly dictates otherwise. Thus, for example, reference to an element described as “a device” may refer to a single device, two devices or any other number of devices. As used in this specification and the appended claims, the term “or” is generally employed in its sense including “and/or” unless the content clearly dictates otherwise.

Unless otherwise indicated, all numbers expressing quantities of elements, dimensions, and so forth used in the specification and claims are to be understood as being modified in all instances by the term “about.” Accordingly, unless indicated to the contrary, the numerical parameters set forth in the preceding specification and attached claims are approximations that can vary depending upon the desired properties sought to be obtained by those skilled in the art utilizing the present description. At the very least, and not as an attempt to limit the application of the doctrine of equivalents to the scope of the claims, each numerical parameter should at least be construed in light of the number of reported significant digits and by applying ordinary rounding techniques. All numerical ranges provided herein, including in the claims, are inclusive unless otherwise noted, such that the numerical limits provided for the range are included in the range, as well as all numbers subsumed with that range. So for example, a range of between 0.05 mm and 0.30 mm includes 0.05 mm, 0.2 mm, 0.234567 mm, and 0.30 mm.

As used herein, the term “coupled” includes direct and indirect connections. Moreover, where first and second devices are coupled, intervening devices including active devices may be located there between.

The description of the various embodiments provided above is illustrative in nature and is not intended to limit the invention, its application, or uses. Thus, variations that do not depart from the gist of the disclosure are intended to be within the scope of the embodiments of the present disclosure. Such variations are not to be regarded as a departure from the intended scope of the present disclosure.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A webcam privacy shield comprising:

2. The device of claim 1, the solution will have a near paper-thin thickness that effectively covers the camera on most electronic devices that have an integrated onboard camera.

3. The device of claim 1, the solution will have an attached or detached, retractable door that allows the camera on the electronic device to be exposed or masked repeatedly as desired by the user.

4. The device of claim 1, the attached embodiment will leverage low-tack adhesive and a crimped hinge to secure masking of the integrated onboard camera.

5. The device of claim 1, the detached embodiment will leverage magnetic properties to secure masking of the integrated onboard camera with both a protective circumference lip and without. The solution will be made of a custom-branded capable substrate where it can be branded in 4-colour designed graphics as opposed to a single colour (white or black) printing capability of similar devices available today.

6. The device of claim 1, the either the detached or attached embodiment can have a form factor footprint custom designed to fit the device for which it was intended (i.e. shape of a basketball, Mickey Mouse ears, etc.). Because of the flexibility of the substrates, the form factor can be designed to specifications.
